(19) United States
(12) Patent Application Publication
(10) Pub. No.: US 2023/0389580 A1
(43) Pub. Date: Dec. 7, 2023

(54) PIGMENT FOR MEAT SUBSTITUTE COMPOSITIONS

(71) Applicant: Cargill, Incorporated, Wayzata, MN (US)

(72) Inventor: Tristan Lipkie, Maple Grove, MN (US)

(73) Assignee: Cargill, Incorporated, Wayzata, MN (US)

(21) Appl. No.: 18/248,992

(22) PCT Filed: Oct. 15, 2021
(86) PCT No.: PCT/US2021/055149

§ 371 Date: Apr. 13, 2023

Related U.S. Application Data
(60) Provisional application No. 63/092,083, filed on Oct. 15, 2020.

(51) Int. Cl. A23L 5/43; A23J 3/22; A23J 3/18

(52) U.S. Cl. CPC A23L 5/43; A23J 3/227; A23J 3/18

(57) ABSTRACT

Disclosed herein are pigment compositions for meat substitutes and meat substitutes including such pigment compositions. The pigment compositions include one or more de-glycosylated betanains. In an aspect, the pigment compositions provide a pink and/or red color to raw meat substitutes that transitions to a brown color after cooking.

### CROSS REFERENCE TO RELATED APPLICATIONS

This application claims the benefit of U.S. Provisional Patent Application No. 63/092,083, filed 15 Oct. 2020, which is hereby incorporated by reference in its entirety.

### BACKGROUND

Demand for plant-based meat substitutes is increasing for a variety of reasons. Many consumers prefer meat substitute options that perform most similarly to animal meat, including wanting the color of the meat substitute to be comparable to animal meat color before and after cooking. Accordingly, there is a need for a pigment that can provide color to a meat substitute that is the same or similar to that of natural animal meat. A pigment derived from plant sources that can transition in color when the meat substitute is cooked is particularly desirable.

### SUMMARY

Described herein are pigment compositions for meat substitutes. In an aspect, the pigment composition comprises one or more de-glycosylated betanains in an amount effective for increasing the red color of a raw or uncooked meat substitute. In an aspect, the one or more de-glycosylated betanains comprise de-glycosylated betanin. In an aspect, the one or more de-glycosylated betanains are obtained from beet juice or beet juice extract treated with beta-glucosidase. In an aspect, the one or more de-glycosylated betanains are obtained from betanin treated with beta-glucosidase. In an aspect, the red color of the composition is decreased when heated to a temperature of at least 80° C. for 90 seconds. In an aspect, after heating the composition for 90 seconds at 130° C., the a* value of L*a*b* colorimetry of the pigment composition decreases by at least 5, 10, 15, 20, 25, 30, 35, 40, 45, or 50%.

This disclosure further relates to meat substitutes comprising such pigment compositions. In an aspect, the meat substitute comprises a non-meat protein, and a pigment composition comprising one or more de-glycosylated betanains. In an aspect, the one or more de-glycosylated betanains comprise de-glycosylated betanin. In an aspect, the one or more de-glycosylated betanains are obtained from beet juice or beet juice extract treated with beta-glucosidase. In an aspect, the one or more de-glycosylated betanains are obtained from betanin treated with beta-glucosidase. In an aspect, the brown color of the meat substitute increases and the red color of the meat substitute decreases after cooking. In an aspect, the non-meat protein is a plant-based protein selected from the group consisting of pea protein, soy protein, and wheat protein. In an aspect, the meat substitute comprises 0.2 to 0.8% by weight of any of the pigment compositions described herein.

This disclosure further relates to methods for improving the color of a meat substitute e.g., by increasing the red color of the meat substitute. In an aspect, the method comprises adding a pigment composition comprising one or more de-glycosylated betanains to a meat substitute prior to cooking the meat substitute. In an aspect, the method comprises adding a pigment composition comprising one or more de-glycosylated betanains to a meat substitute in an amount of 0.2 to 0.8% by weight prior to cooking the meat substitute.

In an aspect, the compositions, meat substitutes, or methods described herein relate to or include a pigment composition comprising at least 50%, 60%, 70%, 80%, 85%, 90%, 95%, or 99% one or more de-glycosylated betanains on a dry weight basis. In an aspect, the compositions, meat substitutes, or methods described herein relate to or include a pigment composition comprising at least 50%, 60%, 70%, 80%, 85%, 90%, 95%, or 99% de-glycosylated betanin on a dry weight basis. In an aspect, the compositions, meat substitutes, or methods described herein relate to or include a pigment composition having a ratio of absorbance at 540 nm to absorbance at 535 nm that is greater than 0.987, 0.995, 0.999, 1.000, 1.005, or 1.009.

### BRIEF DESCRIPTION OF THE FIGURES

The drawings illustrate generally, by way of example, but not by way of limitation, various embodiments discussed in the present document.

FIG. 1 is a photo image of a series of betanin samples, either samples treated with enzyme under various conditions or untreated control samples.

FIG. 2 is a photo image of a series of betanin samples, either samples treated with enzyme under various conditions or untreated control samples; each sample was further heated to 80° C. for 10 min for UV/vis kinetics test.

FIG. 3 is a set of graphs showing visible wavelength absorbance data of the samples from FIG. 2. Each spectra was collected every 0.5 min for 10 min at 80° C. The direction of change across time is indicated with black arrows.

FIG. 4 is a series of photo images of betanin samples, either samples treated with enzyme under various conditions or untreated control samples; each sample was further heating on a hot plate for 2 min at 130° C.

FIG. 5 is a set of photo images (left, raw; right, after heating on a hot plate for 2 min at 130° C.); L*a*b* colorimetry data; and a graph of visible wavelength absorbance data for a beef sample.

FIG. 6 is a set of photo images (left, raw; right, after heating on a hot plate for 2 min at 130° C.); L*a*b* colorimetry data; and a graph of visible wavelength reflection data for a meat substitute sample containing a control pigment sample (beet juice concentrate without enzyme treatment).

FIG. 7 is a set of photo images (left, raw; right, after heating on a hot plate for 2 min at 130° C.); L*a*b* colorimetry data; and a graph of visible wavelength reflection data for a meat substitute sample containing a pigment composition (beet juice concentrate with beta-glucosidase enzyme treatment).

FIG. 8 is a set of photo images (left, raw; right, after heating on a hot plate for 2 min at 130° C.); L*a*b* colorimetry data; and a graph of visible wavelength reflection data for a meat substitute sample containing a pigment composition (beet juice concentrate with peroxidase enzyme treatment).

FIG. 9 is a set of photo images (left, raw; right, after heating on a hot plate for 2 min at 130° C.); L*a*b* colorimetry data; and a graph of visible wavelength reflection data for a meat substitute sample containing a pigment composition (beet juice concentrate with beta-glucosidase and peroxidase enzyme treatment).

### DETAILED DESCRIPTION

Beet derived products such as juices, concentrates, powders, and extracts are currently used as a red pigment for meat substitute products. Beet juice extract contains betalains, predominantly betanin, that provide a red or pink color to the meat substitutes. However, betanin is stable within temperature ranges associated with cooking meat or meat substitutes, and therefore does not transition from red to brown during cooking.

Described herein are pigment compositions for meat substitutes that contain de-glycosylated betalain(s). It has been discovered that enzymatic treatment of betanin (the primary red chemical pigment in beet juice extract) with beta-glucosidase to form the aglycone betanidin results in a pigment composition having a similar red color to betanin before cooking, but the enzymatic treatment makes the pigment composition susceptible to degradation during heating. This degradation of the pigment composition causes the pigment to have a substantially reduced color or become colorless after heating. Accordingly, meat substitutes containing an effective amount of this pigment composition will transition from a red color when raw to a brown or less red color when cooked. In an aspect, the brown color occurs because the pigment composition in the meat substitute becomes at least partially colorless during heating, which allows the brown color resulting from Maillard reactions involving other components of the meat substitute to become more visible than with other pigments used for meat substitutes.

Unless defined otherwise, all technical and scientific terms used herein have the same meaning as commonly understood by one skilled in the art to which this invention belongs. As used herein, each of the following terms has the meaning associated with it as defined below.

As used herein, the terms “meat substitute,” “meat substitute composition” “alternative protein composition,” “meat analogue,” “meat alternative,” “meat alternative composition,” and the like refer to compositions that try to mimic the general appearance, nutritional content, and/or taste of natural animal meat or meat compositions without containing naturally-occurring animal muscle cells or other types of animal cells typically associated with natural animal meat. The terms “meat substitutes” and the like refer to a composition that includes plant-based or fungal-based meat substitutes, such as those based on pea protein, soy protein, wheat protein, chickpeas, or other types of plant proteins or mixtures of plant proteins, and/or those based on mushrooms or other fungal sources. The terms “meat substitute” and the like also include cell-based meat substitutes, i.e., compositions based on animal cells that are produced via fermentation, cell cultures, or other artificial methods. The terms “meat substitute” and the like also include compositions based on insect protein. The terms “meat substitute” and the like also include hybrid compositions that contain a combination of plant-based, insect-based, and/or fungal-based protein in combination with animal cells, including cultured animal cells (i.e., cell-based meat).

As used herein, the term “non-meat protein” refers to protein sourced from plants, fungus, insects, or cultured animal cells.

As used herein, the terms “betalain” or “betalain(s)” refer to betacyanins and/or betaxanthins derived from plants and compositions obtained from plants that contain a significant amount of betacyanins and/or betaxanthins. An exemplary betacyanin is betanin. While the present disclosure describes a particular benefit from using compositions obtained from the de-glycosylation of betanin and/or other betacyanins, it is to be understood that de-glycosylated betaxanthins can also be used in pigment compositions for meat substitutes or other food applications.

Described herein are pigment compositions containing de-glycosylated betalain(s), and meat substitutes including such pigment compositions. The pigment compositions disclosed herein can be used to provide color to a meat substitute that is similar to the color of natural animal meat when raw. Further, these pigment compositions change color upon heating and can provide an overall color change to the entire meat substitute composition that mimics the effects of cooking on natural animal meat. In an aspect, the pigment composition provides a pink and/or red color to raw, uncooked meat substitute that transitions to a brown, white, colorless, or less red color after cooking the meat substitute.

The pigment composition itself loses its pink or red color as it is cooked due to degradation and may become colorless if enough degradation occurs. Accordingly, the brown color of a cooked meat substitute is not necessarily due to the pigment composition turning brown in color, but instead due to the pigment composition losing its reddish color. The degraded pigment composition in the cooked meat substitute no longer masks the other colors of the meat substitute and the brown colors associated with Maillard reactions in the meat substitute become more apparent.

In an aspect, the redness of the pigment composition is reduced substantially or eliminated when heated to a temperature within a range typically used for cooking meat. In an aspect, the pigment composition changes from a pink and/or red color to a less-pink/red color or becomes substantially colorless when diluted 1:10 with water and 1 mL of that solution or slurry is heated on a hot plate set at 130° C. for seconds. In an aspect, the pigment composition can be used to change the color of a meat substitute from a pink and/or red color to a brown color and/or less pink/red color, as exhibited by diluting a meat substitute including the pigment composition 1:10 with water and then heating 1 mL of that solution or slurry to a temperature of 130° C. for 90 seconds. In an aspect, the changes in color of a pigment composition sample can be measured using a Hunter Colorimeter and reported as a relative percent change in visible light absorbance after heating as compared to the sample prior to heating (e.g., by using reflectance peaks in the range of 555-575 nm and 490-510 nm).

In an aspect, the pigment compositions comprise de-glycosylated betalains. Betalains are produced by plants such as beets. In an aspect, the pigment compositions described herein can be made from purified betalains obtained from plants or from unprocessed or slightly processed plant materials, including but not limited to beet juice and beet juice extract.

In an aspect, the de-glycosylated betalains can be obtained by enzymatic treatment. A non-limiting example of such enzymatic treatment includes: obtaining a composition comprising betalain and treating the composition with a de-glycosylating enzyme (e.g., in stirred aqueous slurry) at a temperature in the range of 20 to 40° C. for at least 1 min to obtain a composition comprising de-glycosylated betalains. In an aspect, the pH is modified during the treatment, for example to a pH of 5. In an aspect, the de-glycosylating enzyme comprises beta-glucosidase (EC 3.2.1.21) In an aspect, the enzyme treatment is performed at 35 to 40° C.

In an aspect, the pigment composition comprises one or more de-glycosylated betacyanins. In an aspect, the pigment composition comprises one or more de-glycosylated betacyanins and one or more de-glycosylated betaxanthins. In an aspect, the pigment composition comprises de-glycosylated betanin. In an aspect, the pigment composition comprises one or more de-glycosylated betaxanthins.

In an aspect, the beta-glucosidase enzyme is used at a level of at least at least 0.00001, at least 0.0001, at least 0.001, at least 0.01, at least 0.1, or at least 1 U per mg betanin. In an aspect, the beta-glucosidase enzyme is used at a level of 0.001 to 0.01, 0.004 to 0.016, or 0.0001 to 0.1 U per mg betanin.

The lambda max (wavelength at which absorption is highest) of modified beet juice is 540 nm, whereas the lambda max of unmodified beet juice is 535 nm. The ratio of absorbance at 540 nm to absorbance at 535 nm for unmodified beet juice is less than 1, specifically about 0.987. For partially modified beet juice, the ratio is in the range of about 0.998 to about 1.008. Fully deglycosylated betanidin has a ratio of about 1.010. In an aspect, the pigment composition has a ratio of absorbance at 540 nm to absorbance at 535 nm of greater than 0.987, 0.995, 0.999, 1.000, 1.005, or 1.009. In an aspect, the pigment composition has a ratio of absorbance at 540 nm to absorbance at 535 nm in the range of 0.988 to 1.010, 0.900 to 1.010, 0.995 to 1.010, or 1.000 to 1.010.

The pigment composition can be included in a meat substitute at a level that provides increased or improved pink and/or red color in the raw meat substitute, while also providing increased or improved brown color in the meat substitute after cooking. In an aspect, the pigment composition is used at a level of at least 0.01%, 0.1%, 0.2%, 0.3%, 0.4%, or 0.5% on a wet (total) weight basis in a meat substitute composition. In an aspect, the pigment composition is used at a level in the range of 0.01 to 2%, 0.01 to 1%, 0.1 to 1%, 0.1 to 0.5%, 0.2% to 0.8%, 0.3 to 0.6%, or to 0.5% by weight in a meat substitute composition.

The pigment composition described herein can be used as a pigment in any meat substitute composition. An exemplary, but non-limiting, meat substitute composition is a composition which comprises: plant protein (e.g., textured pea protein and/or pea protein), water, vegetable oil, flavor ingredients, salt, sugar, binders, and the pigment composition described herein. The pigment composition described herein can also be used in food applications other than meat substitutes.

### EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather should be construed to encompass any and all variations which become evident as a result of the teaching provided herein.

### Example 1: Enzyme Modified Betanin for Use as a Meat Substitute Pigment

Betanin is treated with beta-glucosidase and peroxidase enzymes and then heated to determine if such enzyme modified compositions are useful for meat substitute pigment applications.

Betanin (red beet extract diluted with dextrin, obtained from Sigma-Aldrich) is treated with beta-glucosidase (from almonds, lyophilized, powder, >4 U/mg, from Sigma-Aldrich) only, peroxidase (from horseradish, lyophilized, powder, beige, −150 U/mg, from Sigma-Aldrich) only, or both beta-glucosidase and peroxidase. 7 mg/mL betanin is prepared in pH 5 0.1 M sodium acetate buffer. To 3 mL of betanin solution is added 9 mg (40 U) beta-glucosidase and/or 1 mg (120 U) peroxidase. Enzyme treatments are made at either 25° C. or 37° C. for 15 min within a temperature controlled UV/vis spectrophotometer without stirring. Betanin control samples without enzyme treatment are also evaluated. A summary of the samples generated for evaluation is provided in Table 1.

TABLE 1
Summary of sample conditions

| | | | Temperature | |
|---|---|---|---|---|
| | Glucosidase | Peroxidase | during | pH during |
| Sample | treatment | treatment | treatment (° C.) | treatment |
| 1-1 | No | No | N/A | 5 |
| 1-2 | Yes | No | 37 | 5 |
| 1-3 | No | Yes | 37 | 5 |
| 1-4 | Yes | Yes | 37 | 5 |
| 1-5 | Yes | No | 25 | 5 |
| 1-6 | No | Yes | 25 | 5 |
| 1-7 | Yes | Yes | 25 | 5 |
| 1-8 | No | No | N/A | Neutral |

Each of the 8 samples listed in Table 1 was evaluated for color change using two tests: 1) UV/vis kinetics were measured using an Agilent Cary 3500 while heating each sample to 80° C. (which corresponds to the high end of a typical safe beef cooking temperature) and holding at 80° C. for 10 min; and 2) heating the samples on a hot plate set at 130° C. and holding for 2 min after sample starts boiling.

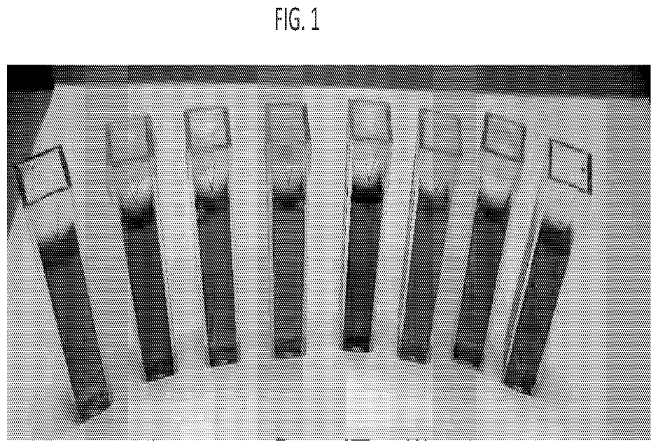

Results are shown in FIGS. 1-4. FIG. 1 shows samples 1-1 through 1-8 (left to right) after enzyme treatment (or control treatment), but before cooking. The enzyme treatment had little or no effect on color of the samples.

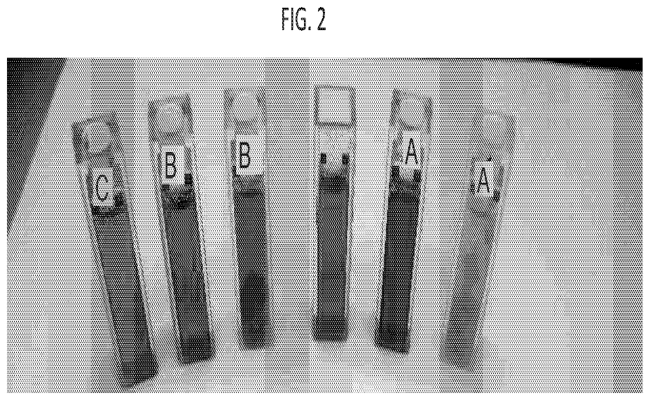

FIG. 2 shows, from left to right, samples 1-8 (control), 1-1 (control), 1-2 (beta-glucosidase treatment only), 1-1 (control), 1-3 (peroxidase treatment only), and 1-4 (both beta-glucosidase and peroxidase treatment) after performing the UV/vis kinetics test (80° C. for 10 min). The sample having beta-glucosidase treatment only (1-2) turned orange in color; the sample having both beta-glucosidase and peroxidase treatment turned yellow in color; and the remaining samples maintained the same red color they demonstrated prior to cooking.

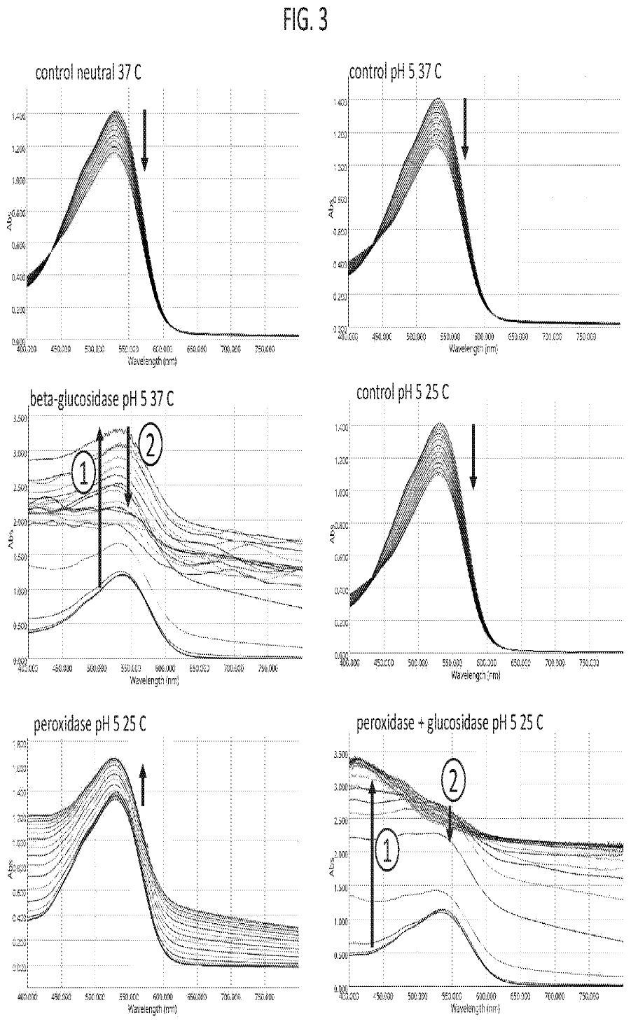

FIG. 3 shows visible wavelength absorbance data associated with the FIG. 2 samples after performing the UV/vis kinetics test (80° C. for 10 min, Spectra were collected every 0.5 min: sample 1-8 (control) absorbance at 450-600 nm decreases with time, 1-1 (control) absorbance at 450-600 nm decreases with time, 1-2 (beta-glucosidase treatment only) absorbance at all wavelengths increases initially as the enzyme is denatured and then absorbance at 450-600 nm decreases, 1-1 (control) absorbance at 450-600 nm decreases with time, 1-3 (peroxidase treatment only) absorbance at all wavelengths increases as the enzyme is denatured, and 1-4 (both beta-glucosidase and peroxidase treatment) absorbance at all wavelengths increases initially as the enzyme is denatured and then absorbance at 450-600 nm decreases Arrows indicate the direction of change vs time, and numbering indicates ordering of spectral change events.

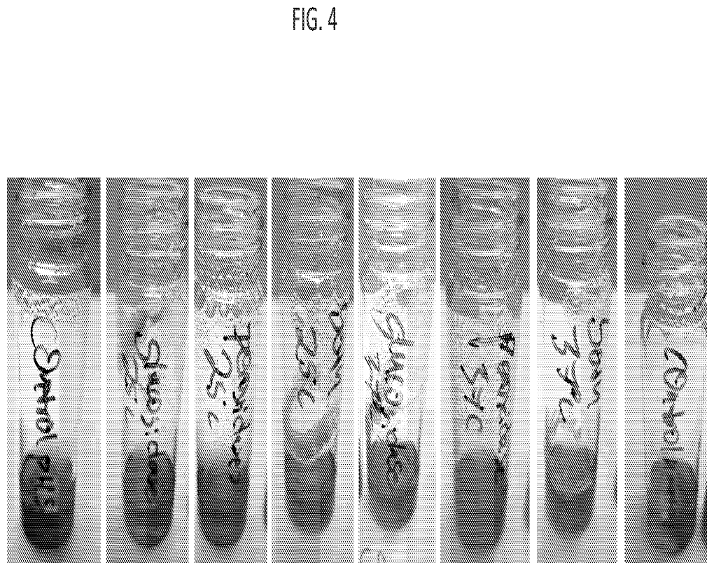

FIG. 4 shows, from left to right, samples 1-1, 1-5, 1-6, 1-7, 1-2, 1-3, 1-4, and 1-8 after heating on a hot plate for 2 min at 130° C. The beta-glucosidase treated samples (1-5 and 1-2) showed fading of redness color and an increase in orange color. The samples treated with both beta-glucosidase and peroxidase (1-7 and 1-4) turned orange in color. Samples treated with beta-glucosidase only (1-5 and 1-2) turned less intense in red, or more pink. All other samples showed no significant color change.

Accordingly, the above results show that beta-glucosidase treatment of betanin alone can provide a composition suitable as a pigment for meat substitute applications.

### Example 2: Application Test of Enzyme-Treated Pigment Compositions

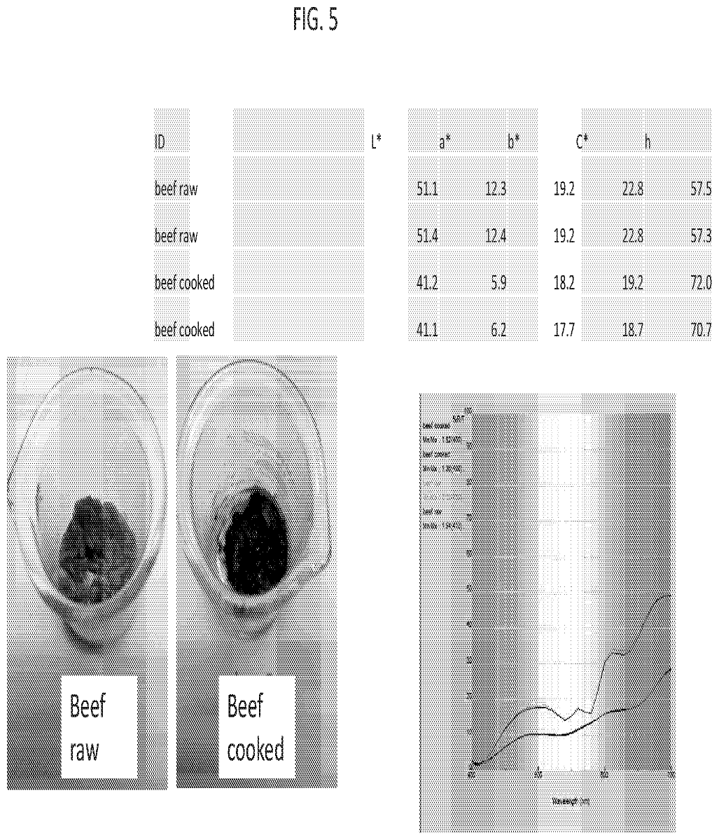

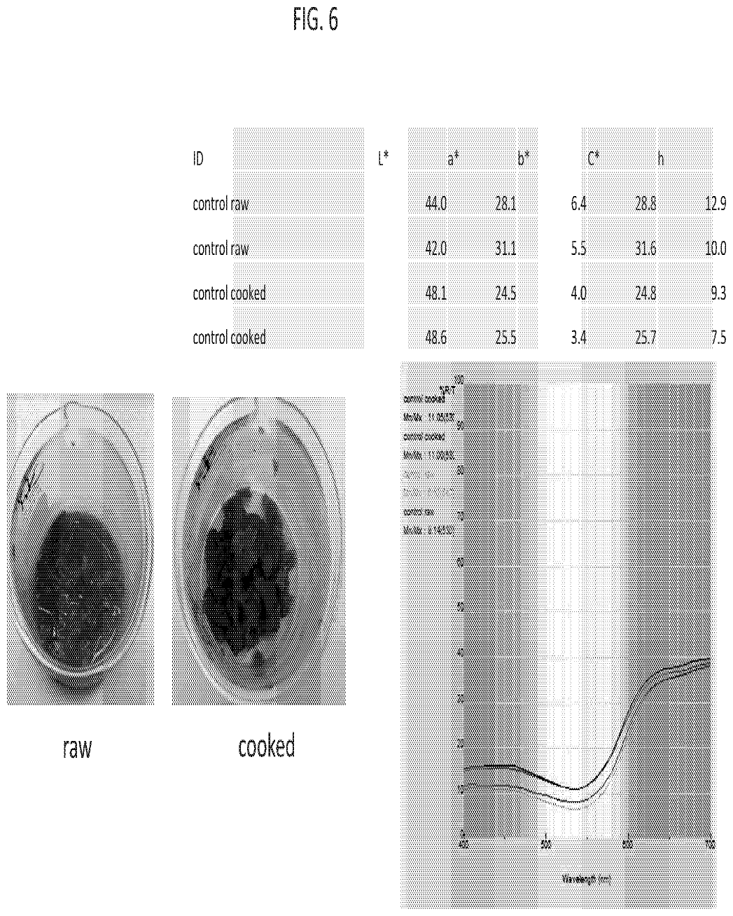

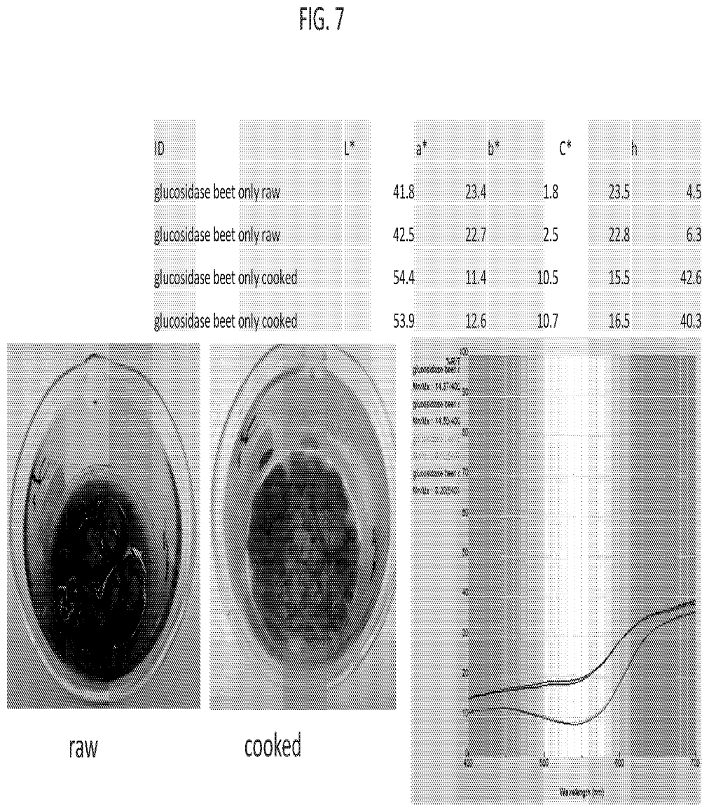

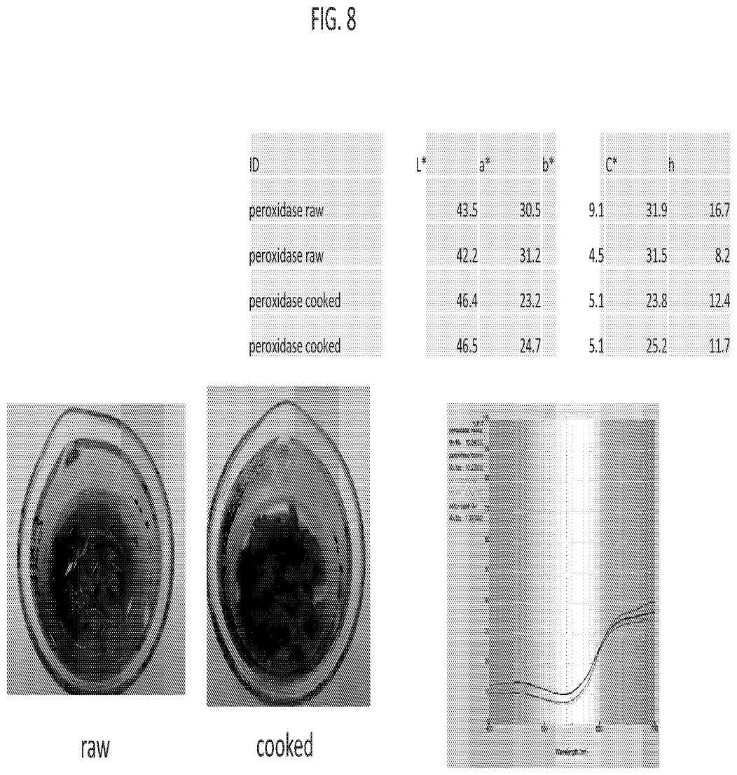

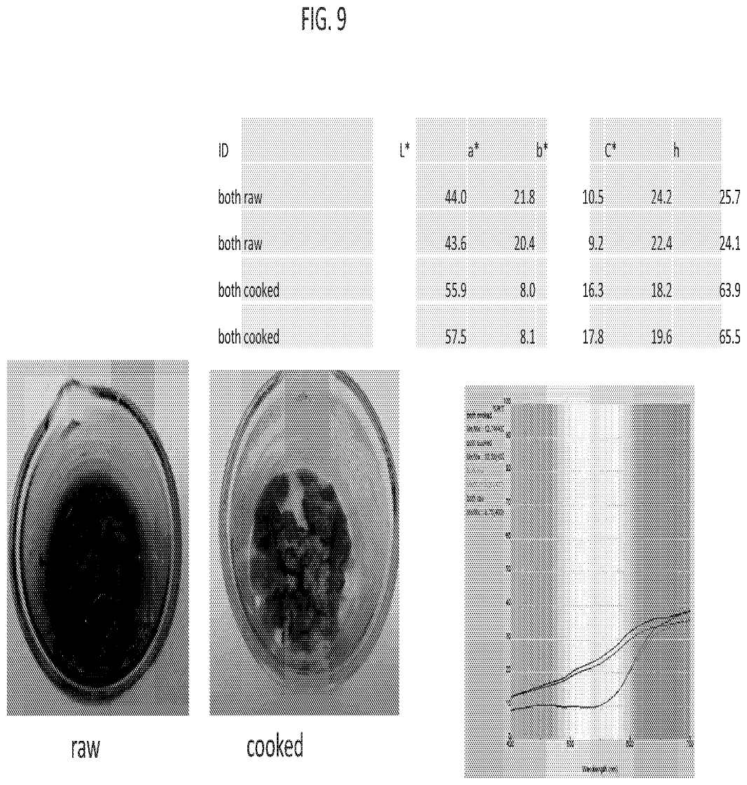

Beet juice concentrate (obtained from Sensient) and beta-glucosidase (same as described in Example 1) are evaluated using the tiny patty application test. Each pigment composition prepared at 37° C. for 15 min sample is mixed with textured pea protein, pea protein, and water, then cooked or 90 seconds at 130° C. A beef sample control of 80/20 ground beef (Cargill) is also cooked for 90 seconds at 130° C. After cooking, reflectance colorimetry is measured using a HunterLab LabScan XE instrument. Colorimetry results are shown in Table 2. FIGS. 5 through 9 each show photo images before (left photo) and after (right photo) cooking and also visible light reflectance graph of the following samples (in sequence): beef, sample 1-1, sample 1-2, sample 1-3, and sample 1-4.

TABLE 2
Colorimetry data

| | raw | | | | | cooked | | | | | delta | | | | |
|---|---|---|---|---|---|---|---|---|---|---|---|---|---|---|---|
| sample | L* | a* | b* | C* | h | L* | a* | b* | C* | h | L* | a* | b* | C* | h |
| Beef | 51.2 | 12.3 | 19.2 | 22.8 | 57.4 | 41.2 | 6.0 | 18.0 | 18.9 | 71.4 | −10.1 | −6.3 | −1.3 | −3.9 | 14.0 |
| control | | | | | | | | | | | | | | | |
| control pH | 49.8 | 19.5 | 16.0 | 25.2 | 39.3 | 55.0 | 16.2 | 11.7 | 20.0 | 35.9 | 5.3 | −3.3 | −4.2 | −5.2 | −3.3 |
| 5 (1-1) | | | | | | | | | | | | | | | |
| glucosidase | 48.9 | 16.9 | 12.5 | 21.0 | 36.5 | 59.4 | 7.8 | 16.9 | 18.6 | 65.2 | 10.5 | −9.1 | 4.4 | −2.4 | 28.6 |
| 37 C. (1-2) | | | | | | | | | | | | | | | |
| peroxidase | 49.6 | 21.0 | 16.2 | 26.5 | 37.6 | 53.9 | 16.2 | 11.4 | 19.8 | 35.2 | 4.3 | −4.8 | −4.8 | −6.7 | −2.4 |
| 37 C. (1-3) | | | | | | | | | | | | | | | |
| glucosidase + | 50.5 | 14.1 | 17.8 | 22.7 | 51.4 | 60.4 | 6.7 | 20.0 | 21.1 | 71.5 | 9.9 | −7.4 | 2.2 | −1.6 | 20.1 |
| peroxidase | | | | | | | | | | | | | | | |
| 37 C. (1-4) | | | | | | | | | | | | | | | |
| glucosidase | 49.2 | 16.0 | 14.1 | 21.4 | 41.4 | 58.4 | 8.4 | 18.8 | 20.6 | 65.9 | 9.2 | −7.6 | 4.6 | −0.8 | 24.5 |
| 25 C. (1-5) | | | | | | | | | | | | | | | |
| peroxidase | 50.1 | 21.0 | 15.1 | 25.9 | 35.7 | 55.0 | 17.1 | 10.6 | 20.1 | 31.7 | 4.9 | −4.0 | −4.6 | −5.8 | −4.0 |
| 25 C. (1-6) | | | | | | | | | | | | | | | |
| glucosidase + | 50.4 | 15.8 | 15.0 | 21.8 | 43.5 | 61.0 | 6.6 | 18.0 | 19.2 | 69.7 | 10.6 | −9.1 | 3.0 | −2.6 | 26.2 |
| peroxidase | | | | | | | | | | | | | | | |
| 25 C. (1-8) | | | | | | | | | | | | | | | |
| control | 50.5 | 19.4 | 11.6 | 22.7 | 30.8 | 54.1 | 16.7 | 9.2 | 19.1 | 28.8 | 3.6 | −2.7 | −2.4 | −3.5 | −2.0 |
| neutral | | | | | | | | | | | | | | | |
| (1-9) | | | | | | | | | | | | | | | |

Meat substitute samples that included beet juice extract treated with beta-glucosidase demonstrated the largest decreases in a* value, which corresponds to red color. Similarly, meat substitute samples that included beet juice extract treated with beta-glucosidase demonstrated the largest increase in h value (hue), which represents change from a red hue (0 degree hue) towards a more yellow hue (90 degree hue).

What is claimed is:

1. A pigment composition for a meat substitute, comprising:
one or more de-glycosylated betanains in an amount effective for increasing the red color of a raw or uncooked meat substitute.

2. The composition of claim 1, wherein the one or more de-glycosylated betanains comprise de-glycosylated betanin.

3. The composition of claim 1, wherein the one or more de-glycosylated betanains are obtained from beet juice or beet juice extract treated with beta-glucosidase.

4. The composition of claim 1, wherein the one or more de-glycosylated betanains are obtained from betanin treated with beta-glucosidase.

5. The composition of claim 1, wherein the red color of the composition is decreased when heated to a temperature of at least 80° C. for seconds.

6. The composition of claim 1, wherein after heating the composition for 90 seconds at 130° C., the a* value of L*a*b* colorimetry of the pigment composition decreases by at least 5%.

7. A meat substitute comprising:
non-meat protein, and
a pigment composition comprising one or more de-glycosylated betanains.

8. The meat substitute of claim 7, wherein the one or more de-glycosylated betanains comprise de-glycosylated betanin.

9. The meat substitute of claim 7, wherein the one or more de-glycosylated betanains are obtained from beet juice or beet juice extract treated with beta-glucosidase.

10. The meat substitute of claim 7, wherein the one or more de-glycosylated betanains are obtained from betanin treated with beta-glucosidase.

11. The meat substitute of claim 7, wherein the brown color of the meat substitute increases and the red color of the meat substitute decreases after cooking.

12. The meat substitute of claim 7, wherein the non-meat protein is a plant-based protein selected from the group consisting of pea protein, soy protein, and wheat protein.

13. The meat substitute of claim 7, wherein the amount of pigment composition in the meat substitute is 0.2 to 0.8% by weight.

14. (canceled)

15. A method for improving the color of a meat substitute, comprising: adding a pigment composition comprising one or more de-glycosylated betanains to a meat substitute prior to cooking the meat substitute.

16. The meat substitute of claim 7, wherein the pigment composition is the composition of claim 5.

17. The meat substitute of claim 7, wherein the pigment composition comprises at least 50% one or more de-glycosylated betanains on a dry weight basis.

18. The meat substitute of claim 7, wherein the pigment composition comprises at least 50% de-glycosylated betanin on a dry weight basis.

19. The meat substitute of claim 7, wherein the ratio of absorbance at 540 nm to absorbance at 535 nm of the pigment composition is greater than 0.987.
